(19) United States
(12) Patent Application Publication
(10) Pub. No.: US 2025/0171341 A1
(43) Pub. Date: May 29, 2025

(54) METHOD AND APPARATUS FOR EFFICIENT AND LOW-CARBON TREATMENT OF LANDFILL LEACHATE BY USING CEMENT KILN

(71) Applicant: CHINESE RESEARCH ACADAMY OF ENVIRONMENTAL SCIENCES, Beijing (CN)

(72) Inventors: Fan WANG, Beijing (CN); Jinwei ZHU, Beijing (CN); Chen ZHANG, Beijing (CN); Hongchang WANG, Beijing (CN); Gang TIAN, Beijing (CN); Yun SHU, Beijing (CN); Jiayu HUANG, Beijing (CN); Yingjie SHI, Beijing (CN); Yuling TAN, Beijing (CN); Hongyan LONG, Beijing (CN); Yutao CUI, Beijing (CN); Yanping ZHANG, Beijing (CN); Fan ZHANG, Beijing (CN)

(73) Assignee: CHINESE RESEARCH ACADAMY OF ENVIRONMENTAL SCIENCES, Beijing (CN)

(21) Appl. No.: 18/839,722

(22) PCT Filed: Nov. 24, 2022
(86) PCT No.: PCT/CN2022/133944

§ 371 Date: Aug. 19, 2024

(30) Foreign Application Priority Data
May 30, 2022 (CN) 202210597719.2

(51) Int. Cl. C02F 9/00; C02F 1/00; C02F 1/12; C02F 101/16; C02F 103/06

(52) U.S. Cl. CPC C02F 9/00; C02F 1/004; C02F 2001/007; C02F 1/12; C02F 2101/16; C02F 2103/06; C02F 2303/16

(57) ABSTRACT

A method and apparatus for efficient and low-carbon treatment of a landfill leachate by using a cement kiln are disclosed. The method comprises the following steps: settling a landfill leachate in a settlement tank, and discharging sludge in the landfill leachate; filtering the landfill leachate subjected to settlement treatment, and controlling the mass concentration of suspended particulate matters in the landfill leachate; and spraying the filtered landfill leachate into a high-temperature region of a decomposition furnace of a cement kiln, the high-temperature region being a region which is at a lower portion of a suspension region of the decomposition furnace of the cement kiln and is at a temperature of 900-1050° C. As a result, coal consumption in the cement kiln can be significantly reduced, carbon dioxide emissions are reduced, processes required for landfill leachate treatment can be simplified, and costs are saved.

### TECHNICAL FIELD

The present disclosure relates to the technical field of low-carbon environmental protection, and more particularly, to a method and apparatus for efficient and low-carbon treatment of a landfill leachate by using a cement kiln.

### BACKGROUND ART

In recent years, with the rapid development of urbanization and industrialization in China, the production of solid waste in China has also increased year by year. In 2018, the production of general industrial solid waste, industrial hazardous waste, medical waste and domestic landfill in 200 large and medium cities in China reached 1.51×10⁹ t, 4.64×10⁷ t, 8.17×10⁵ t and 2.11×10⁸ t, respectively, which posed a serious threat to the ecological environment. The low-carbon treatment of solid waste and domestic landfill by using a cement kiln has become an important way to realize the reduction, harmless disposal and resource utilization of solid waste and domestic landfill in China.

A large quantity of researches and utilizations have been made on the low-carbon treatment of hazardous waste, domestic landfill, municipal and industrial sewage and sludge and other solid waste using cement kilns at home and abroad. As of 2019, more than 20 provinces have built or are promoting the construction of 150 production lines for low-carbon treatment of landfill, sludge and hazardous waste using cement kilns. The moisture content of domestic landfill and sludge is generally 8-15%, and the higher content can reach no less than 20%. A large amount of landfill leachate will be produced in the process of solid waste coprocessing by cement kilns and dumping of industrial sludge and waste. The annual production of landfill leachate in China is up to 10 million tons. The TOC content of landfill leachate is generally 2-10%, the ammonia nitrogen content is up to 1000 mg/L, and it contains a large amount of fluorine and chlorine components. Due to the high concentration, complex composition, complex treatment process and high cost of landfill leachate, soil and groundwater may be polluted. A few coprocessing enterprises adopt the method of spraying water into raw materials and coal, which is very easy to enter soil and groundwater, and at the same time, the waste gas produced by leachate directly enters the air, causing secondary pollution.

At present, it has been studied that the waste liquid of landfill and sludge is injected into a decomposition furnace of the cement kiln, and the organic matter in the leachate is decomposed by heating at high temperature stage. Not only the harmless disposal of the landfill leachate can be realized, but also the organic matter in the waste liquid can be used to achieve the purpose of energy saving.

The landfill leachate contains high concentrations of degradation-resistant organic carbon and ammonia nitrogen components, and under the condition of 8-12% oxygen content, these organic carbon components are combusted at a high temperature to generate gases such as water, nitrogen and carbon dioxide, and emit heat: and the ammonia nitrogen components can generate harmless nitrogen and water at high temperatures. Therefore, low-carbon treatment of landfill leachate by using a cement kiln can replace part of coal, reduce carbon dioxide emissions from the cement kiln, and save the treatment cost of landfill leachate. The chemical reactions that occur are:

CHx+O₂=CO₂+H₂O

NH_{y}+O₂=N₂+H₂O

However, the existing method and apparatus for efficient and low-carbon treatment of landfill leachate by using cement kiln consume more coal and are complicated and expensive.

### SUMMARY OF THE INVENTION

According to the method and apparatus for efficient and low-carbon treatment of a landfill leachate by using a cement kiln provided in the present disclosure, coal consumption in the cement kiln can be significantly reduced, carbon dioxide emissions are reduced, processes required for landfill leachate treatment can be simplified, and costs are saved.

To achieve the above-mentioned purpose, the present disclosure adopts the following technical solutions.

According to one aspect of the present disclosure, there is provided a method for efficient and low-carbon treatment of a landfill leachate by using a cement kiln, including the following steps: S1, settling a landfill leachate in a settlement tank, and discharging sludge in the landfill leachate: S2, filtering the landfill leachate subjected to settlement treatment, and controlling a mass concentration of suspended particulate matters in the landfill leachate: and S3, spraying the filtered landfill leachate into a high-temperature region of a decomposition furnace of a cement kiln, the high-temperature region being a region which is at a lower portion of a suspension region of the decomposition furnace of the cement kiln and is at a temperature of 900-1050° C.

Preferably, in the above-mentioned method for efficient and low-carbon treatment of a landfill leachate by using a cement kiln, in step S2, filtration is performed such that an average diameter of the suspended particulate matters in the landfill leachate is not more than 5 mm and a maximum penetration diameter is not more than 8 mm, and the landfill leachate is controlled such that the mass concentration of the suspended particulate matters in the landfill leachate is not more than 30%.

Preferably, in the above-mentioned method for efficient and low-carbon treatment of a landfill leachate by using a cement kiln, in step S2, the landfill leachate subjected to settlement treatment is filtered through a backwash filter, and the backwash filter is washed by a backwash pump using backwash water, and then the backwash water enters the settlement tank.

Preferably, in the above-mentioned method for efficient and low-carbon treatment of a landfill leachate by using a cement kiln, in step S3, a residence time of the landfill leachate in the decomposition furnace of the cement kiln is not less than 5 s, an oxygen content of flue gas in the decomposition furnace of the cement kiln is 8-12%, and a ratio of an injected amount of the landfill leachate to a throughput of a clinker of the cement kiln is not more than 1:100.

Preferably, in the above-mentioned method for efficient and low-carbon treatment of a landfill leachate by using a cement kiln, in step S3, the filtered landfill leachate is injected into the high-temperature region of the decomposition furnace of the cement kiln using a single fluid spray gun.

Preferably, in the above-mentioned method for efficient and low-carbon treatment of a landfill leachate by using a cement kiln, in the step S3, a pressure of the landfill leachate entering a single fluid spray gun is 0.4-0.6 MPa, a flow rate is 150 kg/h-200 kg/h, and a temperature of the flue gas at a position of an ejection port of the single fluid spray gun is set at 989° C.-1002° C.

In accordance with another aspect of the present disclosure, there is provided an apparatus for efficient and low-carbon treatment of a landfill leachate by using a cement kiln, including: a buffer tank, a settlement tank, a backwash filter, a landfill leachate storage tank, a pressurizing pump, 4-8 spray guns, and a decomposition furnace of a cement kiln, wherein an outlet of the buffer tank is connected to an inlet of the settlement tank, a middle outlet of the settlement tank is connected to an inlet of the backwash filter, an outlet of the backwash filter is connected to an inlet of the landfill leachate storage tank, an outlet of the landfill leachate storage tank is connected to an inlet of the pressurizing pump, an outlet of the pressurizing pump is connected to the spray guns, and the spray guns are opened on a side wall of a region, having a temperature in a range of 900-1050° C., in the decomposition furnace of the cement kiln.

Preferably, in the above-mentioned apparatus for efficient and low-carbon treatment of a landfill leachate by using a cement kiln, the spray guns are single fluid spray guns, and the spray guns are uniformly opened on the side wall of the decomposition furnace of the cement kiln.

Preferably, in the above-mentioned apparatus for efficient and low-carbon treatment of a landfill leachate by using a cement kiln, the apparatus further includes a fresh water storage tank and a backwash pump, the fresh water storage tank being connected to the settlement tank through the backwash pump and the backwash filter in sequence.

Preferably, in the above-mentioned apparatus for efficient and low-carbon treatment of a landfill leachate by using a cement kiln, a filtration lifting pump is further provided between the middle outlet of the settlement tank and the backwash filter, and a lower outlet of the settlement tank is connected to the sludge tank.

### Advantageous Effects of the Present Disclosure

The method and apparatus for efficient and low-carbon treatment of a landfill leachate by using a cement kiln according to the present disclosure reduce the ammonia nitrogen in the landfill leachate to generate harmless nitrogen and water, and make full use of the heat generated by combustion of total organic carbon without secondary pollution, so that coal consumption in the cement kiln can be saved and the emission of carbon dioxide can be reduced, and the process required for the treatment of the landfill leachate can be simplified and the cost can be saved.

### BRIEF DESCRIPTION OF THE DRAWINGS

In order to more clearly illustrate the specific implementations of the present disclosure or the technical solutions in the prior art, a brief description will be given below of the accompanying drawings which are used as required in the description of the specific implementations or the prior art.

FIG. 1 is a schematic flow diagram of a method for efficient and low-carbon treatment of a landfill leachate by using a cement kiln according to the present disclosure: and

FIG. 2 is a schematic process flow diagram of an apparatus for efficient and low-carbon treatment of a landfill leachate by using a cement kiln according to the present disclosure.

### DETAILED DESCRIPTION OF THE INVENTION

The technical solutions of the present disclosure will now be described clearly and fully hereinafter with reference to the embodiments of the present disclosure. It is to be understood that the embodiments described are only a few, but not all embodiments of the present disclosure. Based on the embodiments of the present disclosure, all other embodiments obtained by a person skilled in the art without involving any inventive effort fall within the scope of protection of the present disclosure.

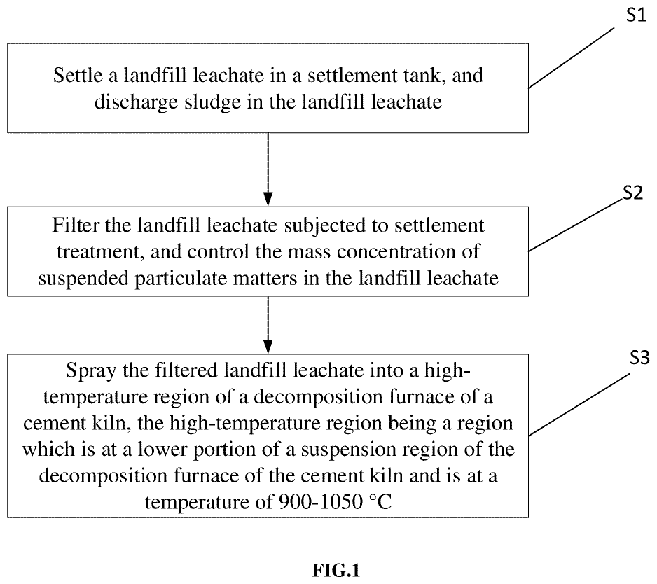

As shown in FIG. 1, the method for efficient and low-carbon treatment of a landfill leachate by using a cement kiln according to the present disclosure includes the following steps:
S1. The landfill leachate is settled in a settlement tank, and sludge is discharged in the landfill leachate.
S2. The landfill leachate subjected to settlement treatment is filtered, and a mass concentration of suspended particulate matters in the landfill leachate is controlled. The landfill leachate is filtered using a backwash filter such that an average diameter of the suspended particulate matters in the landfill leachate is not more than 5 mm and a maximum penetration diameter is not more than 8 mm, and the mass concentration of the suspended particulate matters in the landfill leachate is controlled to be not more than 30% in order to prevent clogging of the spray gun: the backwash filter is backwashed with backwash water through the backwash pump, then the backwash water enters into the settlement tank. The backwash water removes impurities trapped in a filter bed of the backwash filter, allowing the filtration capacity of the backwash filter to recover in a short period of time.
S3. The filtered landfill leachate is sprayed into a high-temperature region of a decomposition furnace of a cement kiln, the high-temperature region being a region which is at a lower portion of a suspension region of the decomposition furnace of the cement kiln and is at a temperature of 900-1050° C.

The landfill leachate is injected into the high-temperature region of the decomposition furnace of the cement kiln using a single fluid spray gun, an opening of the spray gun is located at a lower portion of the decomposition furnace, 4-8 single fluid spray guns are usually provided, a pressure of the landfill leachate entering the single fluid spray gun is 0.4-0.6 MPa, a flow rate is 150 kg/h-200 kg/h, and a temperature of flue gas at a portion of an ejection port is 989-1002° C. The ratio of an injected amount of the landfill leachate to a throughput of a clinker of the cement kiln is not more than 1:100, a residence time of the landfill leachate in the decomposition furnace of the cement kiln is not less than 5 s, and an oxygen content of the flue gas in the decomposition furnace of the cement kiln is 8-12%. In this step, organic matter in the leachate is decomposed by heating in the high-temperature region of the decomposition furnace of the cement kiln, and the ammonia nitrogen in the landfill leachate is reduced to generate harmless nitrogen and water, etc. so as to make full use of the heat generated by combustion of total organic carbon without secondary pollution, which can save coal consumption of the cement kiln and reduce carbon dioxide emissions.

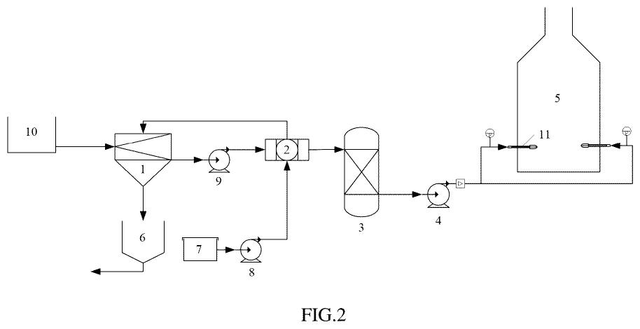

As shown in FIG. 2, the apparatus for efficient and low-carbon treatment of a landfill leachate by using a cement kiln of the present disclosure includes a buffer tank 10, a settlement tank 1, a backwash filter 2, a landfill leachate storage tank 3, a pressurizing pump 4, a spray gun 11, a decomposition furnace 5 of the cement kiln, a sludge tank 6 and a fresh water storage tank 7, wherein an outlet of the buffer tank 10 is connected to an inlet of the settlement tank 1, a middle outlet of the settlement tank 1 is connected to an inlet of the backwash filter 2 through a filtration lifting pump 9, an outlet of the backwash filter 2 is connected to an inlet of the landfill leachate storage tank 3, an outlet of the landfill leachate storage tank 3 is connected to an inlet of the pressurizing pump 4, an outlet of the pressurizing pump 4 is connected to the spray guns 11, and the spray guns 11 are opened on a side wall of a region, having a temperature in a range of 900-1050° C., of a lower portion of the decomposition furnace 5 of the cement kiln.

The landfill leachate enters the landfill leachate storage tank 3 from the buffer tank 10 through the settlement tank 1 and the backwash filter 2, a lower outlet of the settlement tank 1 is connected to the sludge tank 6, the sludge in the landfill leachate enters the sludge tank 6 from a lower portion of the settlement tank 1, and the sludge collected in the sludge tank 6 is incorporated into raw materials for harmless disposal.

The outlet of the fresh water storage tank 7 is connected to the inlet of the settlement tank 1 via a pipeline, specifically, the fresh water storage tank 7 is connected to the settlement tank 1 through a backwash pump 8 and the backwash filter 2 in sequence, the backwash water enters the settlement tank 6 from the fresh water storage tank 7 through the backwash pump 8 and the backwash filter 2 in sequence, and the backwash water removes impurities trapped in a filter bed of the backwash filter 2, so that the filtration capacity of the backwash filter 2 recovers in a short period of time.

In a preferred embodiment, 4-8 single fluid spray guns 11 are provided, and the spray guns 11 are uniformly opened on a side wall in the decomposition furnace 5 of the cement kiln.

### Embodiment 1

A 2500 t/d cement clinker production line was used for low-carbon treatment of landfill leachate. The landfill leachate came from a nearby small urban domestic landfill, and the amount of landfill leachate treated per day was up to about 10 tons, with an average of 7 t/d. The landfill leachate was taken from the outlet of the settlement tank, a content of total suspended matters was less than 1%, a TOC content was 12.86%, a total carbon content was 8.52%, and an ammonia nitrogen content was 1080 mg/L.

The landfill leachate was transported to a cement plant via a waste water tank truck, and the landfill leachate was filtered through a primary filter before entering a waste water storage tank, wherein the primary filter required a particle size of 1 mm to pass through, and an outlet of the waste water storage tank (namely, the landfill leachate storage tank) was connected to a spray gun via a pressurizing pump. The pressure of the landfill leachate was stabilized by controlling an injected flow rate through a waste water flow meter after the pressurizing pump. An amount of suspended particulate matters collected through the filter was extremely low, only 5 kg/year, and these waste residues were incorporated into cement raw materials and re-enter the rotary kiln for combustion, so that harmful components completely became harmless.

By arranging four landfill leachate single fluid spray guns in the lower portion of the decomposition furnace, each spray gun has a design flow of 150 kg/h. A temperature of the flue gas at a position of the ejection port was 989-1002° C. After the implementation of the project, the emission of flue gas from kiln tail met the relevant national emission standards. The concentration of carbon monoxide in the flue gas from the kiln tail was lower than 55 mg/m³, which was far lower than the limit required by the existing domestic landfill incineration standards. At present, there was no national emission standard limit for carbon monoxide from domestic landfill treated by cement kilns. The amount of landfill leachate actually treated in this embodiment was 0.52 m³/h, about 3640 m³ of landfill leachate was treated annually, and the waste water treatment cost was close to zero. According to 7000 hours of production per year, 279.5 tons of standard coals can be saved every year, and the carbon dioxide emission is 731.85 tons.

### Embodiment 2

A 4000 t/d cement clinker production line was used for low-carbon treatment of landfill leachate. The amount of landfill leachate treated was 24 t/d. domestic landfill was derived from municipal domestic landfill collected in a city. One source of landfill leachate was landfill leachate produced by percolating through a grid plate at a bottom of a landfill storage pit into a landfill leachate storage pit, and the other source was landfill leachate produced by an extruder after water washing of the landfill. Both types of landfill leachate entered the landfill leachate storage pit.

The landfill leachate entered the leachate buffer tank from the landfill leachate storage pit, the designed capacity of the leachate buffer tank was 5 m³, then the landfill leachate entered the settlement tank, and then entered the landfill leachate storage tank through the backwash filter, a maximum designed treatment capacity of the settlement tank was 2 m³/h, a diameter was 1.0 m, a depth of the tank was H=3.0 m, a size of the sludge tank was Φ3 m×3 m, a designed treatment capacity of the backwash filter was 30 t/d, and an effective volume of the landfill leachate storage tank was 28 m³.

The content of the total organic carbon of the landfill leachate in the landfill leachate storage tank was 8.74%, and the total carbon content was 6.92%. The amount of actually treated landfill leachate was 0.92 m³/h, the throughput of cement clinker was 175.8 t/h, and a ratio of the throughput of the cement clinker to a treated weight of the landfill leachate was 0.005. About 0.36 ton per day of no less than 80% of the sludge was collected through the sludge tank, and this part of the sludge was totally incorporated into the cement raw materials by a sludge pump. Six landfill leachate spray guns were installed in the decomposition furnace, a designed flow rate of each spray gun was 200 kg/h, an opening of the spray gun was located at a lower portion of the decomposition furnace and 8.5 m below an SNCR denitration spray gun, and an average temperature was 982° C. After the implementation of the project, the emission of flue gas from the kiln tail met the relevant national emission standards. This embodiment treated 8059 tons of landfill leachate per year, while allowing substantial savings in waste water treatment. According to the calculation, 557.7 tons of standard coals can be saved every year, and the carbon dioxide emission is 1371.9 tons.

The description is only specific implementations of the present disclosure, but the scope of protection of the present disclosure is not limited thereto, and any changes and substitutions which can be easily made by a person skilled in the art within the technical scope of the present disclosure disclosed are within the scope of protection of the present disclosure. Accordingly, the scope of protection sought herein is as set forth in the claims below.

1. A method for efficient and low-carbon treatment of a landfill leachate by using a cement kiln, comprising the steps of:
settling the landfill leachate in a settlement tank, and discharging sludge in the landfill leachate;
filtering the landfill leachate subjected to settlement treatment, and controlling a mass concentration of suspended particulate matters in the landfill leachate; and
spraying the filtered landfill leachate into a high-temperature region of a decomposition furnace of a cement kiln, the high-temperature region being a region which is at a lower portion of a suspension region of the decomposition furnace of the cement kiln and is at a temperature of 900-1050° C.

2. The method for efficient and low-carbon treatment of a landfill leachate by using a cement kiln according to claim 1, wherein, in the filtering step, filtration is performed such that an average diameter of the suspended particulate matters in the landfill leachate is not more than 5 mm and a maximum penetration diameter is not more than 8 mm, and the landfill leachate is controlled such that the mass concentration of the suspended particulate matters in the landfill leachate is not more than 30%.

3. The method for efficient and low-carbon treatment of a landfill leachate by using a cement kiln according to claim 1, wherein, in the filtering step, the landfill leachate subjected to settlement treatment is filtered through a backwash filter, and the backwash filter is washed by a backwash pump using backwash water, and then the backwash water enters the settlement tank.

4. The method for efficient and low-carbon treatment of a landfill leachate by using a cement kiln according to claim 1, wherein, in the spraying step, a residence time of the landfill leachate in the decomposition furnace of the cement kiln is not less than 5 s, an oxygen content of flue gas in the decomposition furnace of the cement kiln is 8-12%, and a ratio of an injected amount of the landfill leachate to a throughput of a clinker of the cement kiln is not more than 1:100.

5. The method for efficient and low-carbon treatment of a landfill leachate by using a cement kiln according to claim 1, wherein, in the spraying step, the filtered landfill leachate is injected into the high-temperature region of the decomposition furnace of the cement kiln using a single fluid spray gun.

6. The method for efficient and low-carbon treatment of a landfill leachate by using a cement kiln according to claim 4, wherein, in the spraying step, a pressure of the landfill leachate entering a single fluid spray gun is 0.4-0.6 MPa, a flow rate is 150 kg/h-200 kg/h, and a temperature of the flue gas at a position of an ejection port of the single fluid spray gun is set at 989° C.-1002° C.

7. An apparatus for efficient and low-carbon treatment of a landfill leachate by using a cement kiln, comprising: a buffer tank, a settlement tank, a backwash filter, a landfill leachate storage tank, a pressurizing pump, 4-8 spray guns, and a decomposition furnace of a cement kiln, wherein an outlet of the buffer tank is connected to an inlet of the settlement tank, a middle outlet of the settlement tank is connected to an inlet of the backwash filter, an outlet of the backwash filter is connected to an inlet of the landfill leachate storage tank, an outlet of the landfill leachate storage tank is connected to an inlet of the pressurizing pump, an outlet of the pressurizing pump is connected to the spray guns, and the spray guns are opened on a side wall of a region, having a temperature in a range of 900-1050° C., in the decomposition furnace of the cement kiln.

8. The apparatus for efficient and low-carbon treatment of a landfill leachate by using a cement kiln according to claim 7, wherein the spray guns are single fluid spray guns, and the spray guns are uniformly opened on the side wall of the decomposition furnace of the cement kiln.

9. The apparatus for efficient and low-carbon treatment of a landfill leachate by using a cement kiln according to claim 7, wherein the apparatus further comprises a fresh water storage tank and a backwash pump, the fresh water storage tank being connected to the settlement tank through the backwash pump and the backwash filter in sequence.

10. The apparatus for efficient and low-carbon treatment of a landfill leachate by using a cement kiln according to claim 7, wherein a filtration lifting pump is further provided between the middle outlet of the settlement tank and the backwash filter, and a lower outlet of the settlement tank is connected to the sludge tank.
